(19) United States
(12) Patent Application Publication
(10) Pub. No.: US 2025/0341478 A1
(43) Pub. Date: Nov. 6, 2025

(54) AUTOMATED MONITORING OF DEFECTS IN WIRELINE CABLES

(71) Applicant: RIER 1 ENERGY SOLUTIONS, INC., Edmonton (CA)

(72) Inventors: Jeffrey Golinowski, Edmonton (CA); Hassan Murched, Edmonton (CA); Kyle Davies, Edmonton (CA)

(21) Appl. No.: 19/197,083

(22) Filed: May 2, 2025

Related U.S. Application Data
(60) Provisional application No. 63/642,280, filed on May 3, 2024.

(51) Int. Cl. G01N 21/952; G01N 21/88

(52) U.S. Cl. CPC G01N 21/952; G01N 21/8806; G01N 21/8851; G01N 2201/126

(57) ABSTRACT

Disclosed examples generally relate to automated monitoring of defects in wireline cables. In at least one examples, the method for automated detection of defects in wireline cables includes inputting one or more image frames, captured of a wireline cable portion at a given time instance using an imaging subsystem, into a trained image analysis model, wherein the model is trained to predict the presence of defects in imaged wireline cables; based on an output of the trained image analysis model, determining the presence of one or more defects in the imaged wireline cable portion; and if one or more defects are detected, generating an output.

### CROSS-REFERENCE TO RELATED APPLICATION(S)

The present application claims priority to, and the benefit of, U.S. Provisional Patent Application No. 63/642,280, titled “AUTOMATED MONITORING OF DEFECTS IN WIRELINE CABLES”, filed on May 3, 2024, the entire contents of which are incorporated herein by reference.

### FIELD

Various embodiments are described herein that generally relate to inspection and maintenance of wireline cables, and in particular, to automated monitoring of defects in wireline cables.

### BACKGROUND

Supply chains, for the provision of natural gas, are complex operations which are vulnerable to disruption. One important source of vulnerability stems from unexpected failures in the wireline cable equipment, e.g., used in gas well preparation. To prevent unexpected failures, wireline cables are subject to routine visual inspection by operators. Visual inspections of wireline cables, however, often yields marginal results which are error-prone, subjective, and inconsistent.

### SUMMARY

According to one broad aspect, there is disclosed a method for automated detection of defects in wireline cables, comprising: analyzing, using a trained image analysis model, one or more image frames, captured of a wireline cable portion at a given time instance using an imaging subsystem, wherein the model is trained to predict the presence of defects in imaged wireline cables; based on an output of the trained image analysis model, determining the presence of one or more defects in the imaged wireline cable portion; and if one or more defects are detected, generating an output.

In some examples, the method comprises, initially, operating the imaging subsystem to capture the one or more image frames, wherein the imaging subsystem comprises at least three imaging sensors, each operable to capture a corresponding image frame of the wireline cable portion.

In some examples, the imaging sensors are arranged around an imaging area to provide a 360° circumferential view of the wireline cable portion, and are supported by an imaging hardware assembly.

In some examples, the imaging sensors are arranged in a triangular configuration.

In some examples, the trained image analysis model is a trained YOLOX model.

In some examples, prior to inputting the image frames, the method comprises combining the image frames to generate a stacked image frame, and inputting the stacked image frame into the trained image analysis model.

In some examples, the trained image analysis model is also trained to predict one or more defect features.

In some examples, the defect features include one or more of defect type, defect severity, pixel location of defect within the one or more image frames.

In some examples, the output comprises a user notification of a detected defect.

In some examples, the method further comprises generating a defect output dataset comprising one or more of: (i) an indication of the presence of the defect in the image frames; and (ii) one or more defect features; and associating the defect output dataset with one or more of the image frames.

In some examples, the method further comprises iterating the method for a length of wireline and generating a wireline output dataset comprising a plurality of defect output datasets.

In some examples, the one or more defects comprise one or more first defects, and the method further comprises: analyzing laser measurement data, of the wireline cable portion captured using a laser subsystem, using a trained laser analysis model, the trained laser analysis model being trained to predict the presence of one or more second defects in the wireline cable portion based on the laser measurement data; based on the analysis, determining the presence of one or more second defects in the wireline cable portion; and if one or more second defects are detected, generating the defect output dataset to include an indication of the one or more second defects.

In some examples, the method further comprises operating the laser subsystem to capture the laser measurement data of the wireline cable portion, wherein the laser subsystem comprises one or more laser sources, as well as laser sensors which generate the laser measurement data.

In some examples, the trained laser analysis model is a binary classification gradient-boosted tree with XGBoost.

In another broad aspect, the system for automated detection of defects in wireline cables, comprises: an imaging subsystem configured to generate one or more image frames, captured of a wireline cable portion at a given time instance; a memory for storing a trained image analysis model, wherein the model is trained to predict the presence of defects in imaged wireline cables; and at least one processor coupled to the memory and imaging subsystem, and configured for: applying a trained image analysis model to the one or more image frames; based on an output of the trained image analysis model, determining the presence of one or more defects in the imaged wireline cable portion; and if one or more defects are detected, generating an output.

In some examples, the imaging subsystem comprises at least three imaging sensors, each operable to capture a corresponding image frame of the wireline cable portion.

In some examples, the imaging sensors are arranged around an imaging area to provide a 360° circumferential view of the wireline cable portion, and are supported by an imaging hardware assembly.

In some examples, the trained image analysis model is also trained to predict one or more defect features.

In some examples, the one or more defects comprise one or more first defects, the system further comprising a laser subsystem configured to generate laser measurement data of the wireline cable portion, and wherein the memory is configured to store a trained laser analysis model trained to predict the presence of one or more second defects in the wireline cable portion based on the laser measurement data, and the at least one processor is further configured for: analyzing the laser measurement data using the trained laser analysis model; based on the analysis, determining the presence of the one or more second defects in the wireline cable portion; and if one or more second defects are detected, generating the defect output dataset to include an indication of the one or more second defects.

In some examples, the laser subsystem comprises one or more laser sources, as well as laser sensors which generate the laser measurement data.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an illustration of an example environment for applying the disclosed systems and methods;

FIG. 2A is an example imaging hardware assembly, used in a wireline cable defect monitoring system;

FIG. 2B is an example arrangement of imaging sensors in a monitoring system;

FIG. 2C is example combined laser and imaging hardware assembly, used in a wireline cable defect monitoring system;

FIG. 3A is a process flow for an example method for detecting defects in wireline cables;

FIG. 3B is a process flow for another example method for detecting defects in wireline cables;

FIG. 3C is a process flow for an example method for outputting historical wireline output data;

FIG. 4A is an example output of a trained image analysis model;

FIG. 4B are illustrations of example cross-sections of wireline cables, showing various cable ovality features;

FIG. 4C are various example images captured of defected wireline cables;

FIGS. 5A-5C show various example graphical user interfaces (GUIs);

FIGS. 5D-5G show various images of the accuracy of the image analysis models;

FIG. 6 is an example overall system for monitoring wireline cable defects; and

FIG. 7 is a simplified electrical hardware block diagram of an example wireline cable defect monitoring system.

Further aspects and features of the example embodiments described herein will appear from the following description taken together with the accompanying drawings.

### DETAILED DESCRIPTION

Embodiments herein generally relate to systems and methods for automated monitoring of defects in wireline cables, such as wireline cables used in preparing oil and gas wells. In some examples, the disclosed embodiments allow for predictive maintenance of wireline cables.

### I. General Overview

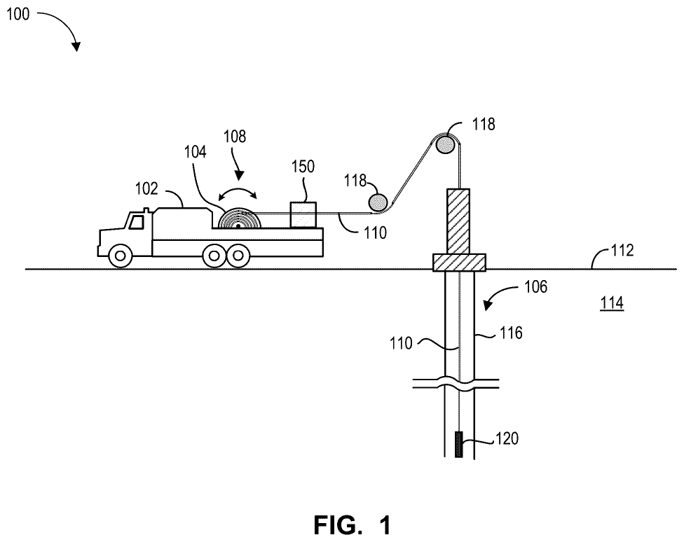

FIG. 1 illustrates an example environment (100) for applying the disclosed systems and methods.

In the illustrated example, a wireline operation is performed in the course of preparing a gas or oil well (106). The wireline operation is used, for example, to complete a plug-and-perf operation, as known in the art.

As shown, wireline truck (102) carries a wireline cabling system (104), such as a wireline drum (108). Typically, several kilometers of wireline cable (110) are spooled around the drum (108). The wireline (110) can include sophisticated assemblies of cables, wires or other conductors.

In operation, wireline drum (108) is controlled to release or retract wireline (110) into or out of well (106), e.g., by rotating clockwise or counterclockwise. A bottom hole assembly (BHA) (120) is typically attached to a terminal end of the wireline inserted into the well. The BHA can include various equipment used for well preparation and assessment (e.g., sensors, perforating guns, etc.).

As further illustrated, the gas or oil well (106) extends below ground (112), into a subsurface formation (114). The gas or oil well can include a well hole surrounded by a casing (116). A series of pulleys and other equipment (118) may guide the descent and retraction of the wireline (110) into and out of the well (106).

As used herein, a wireline “run” refers to a single instance of either running the wireline and BHA, into or out of, the well (106). Running the wireline into the well (106) is called a “run in hole” (RIH), while running the wireline out of the well (106) is called a “pull out of hole” (POOH). A “stage” refers to a single RIH followed by a POOH.

To that end, continuous insertion and retrieval of wireline cable (110) into and out of well (106) results in a buildup of defects (e.g., damage, bends, improper torsion and wear, etc.) to the wireline. The accumulated wear-and-tear, as well as other damage, eventually breaks the wireline cable over time. A “catastrophic failure event” occurs when the wireline cable breaks inside the well. Mitigating a catastrophic failure event can be costly, especially where the well site is remotely located, which requires long-distance transportation of heavy repair equipment and personnel. More generally, use of damaged wireline may result in expensive damage to other wireline equipment.

In view of this, early maintenance of wireline cables is critical to avoiding catastrophic failure events, and to otherwise extend the wireline's service life. This, in turn, minimizes disruptions to operations, as well as costly delays to the overall gas and/or oil supply chain.

The primary means for monitoring defects, in wireline cables, is through visual inspection. During operations, wireline operators visually inspect wireline cables for defects while the wireline cable is inserted and retrieved from well (106).

The task of visual inspection is made difficult, however, as the operator must both inspect the wireline cable, while concurrently monitoring sensor readings from the attached bottom hole assembly (BHA) (120). The operator is often unable to balance these two tasks simultaneously.

Additionally, some defects may be visually imperceptible to the operator. This is owing, for instance, to the speed at which the wireline cable is inserted and retrieved from well (106).

By way of example, an 8000-meter-long wireline cable typically passes the operator's line of sight at around 250 meters/minute. At these speeds, it may be impossible for the operator to visually identify every defect in the wireline cable. Even if visual inspection at this rate is possible, not all surfaces of the cylindrical wireline cable are visible to the operator from any given viewpoint. For instance, defects in the underside of the wireline cable are often hidden from sight.

For these reasons, visual inspection of wireline cables yields marginal results which are subjective, error-prone and inconsistent. The safest way to prevent high-cost, high-risk wireline cable failures is to often simply to discard wireline cables after they pass a certain stage count, and before they reach the end of their possible lifetime use.

In view of the foregoing, disclosed embodiments provide for methods and systems for automated detection (and identification) of defects in wireline cables. In at least one example, trained machine learning models are used for automated defect detection.

As detailed herein, it is believed that the disclosed examples provide for an efficient method for conducting extensive and automated inspection of wireline cables, as well as identifying damage unperceivable by human inspectors. In turn, this avoids failures in wireline operations due to unforeseen destruction of wireline cables.

More generally, disclosed examples are also believed to allow for better prediction of the need for maintenance, which can improve production efficiency by extending the lifetime use of wireline cables and otherwise avoid significant production delays caused by wireline cables breaking, e.g., at remote gas extraction sites. This also supports the timely provision of wireline cable materials by foreseeing well in advance when wireline cables need replacement. This, in turn, can reduce disruptions in gas extraction and avoid significant costs from project delays.

### II. Example Wireline Cable Defect Monitoring System

As exemplified in FIG. 1, a “wireline cable defect monitoring system” (150) is provided (also referred to herein as a “defect monitoring system”, or simply, a “monitoring system”). The defect monitoring system (150) is used for automated detection of defects in wirelines.

As exemplified, a portion of the wireline cable (110) is passed through the monitoring system (150). This allows the system (150) to automatically inspect the wireline cable profile for defects, as the wireline cable is inserted and/or retrieved from well hole (106).

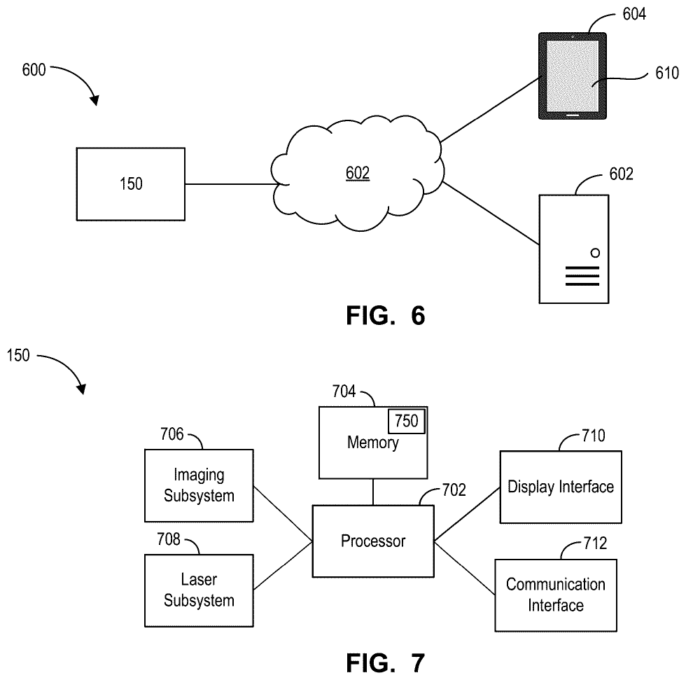

In at least one example, monitoring system (150) hosts trained machine learning models. The trained models are used for detecting and identifying defects in wirelines. In this manner, the monitoring system (150) provides an “edge-AI” solution, whereby the AI models are hosted directly on the local system. In other examples, the monitoring system (150) can communicate data to a remote server, which itself hosts the trained models (e.g., server (602) in FIG. 6).

In the illustrated example (FIG. 1), the defect monitoring system (150) is mounted directly to the wireline truck (102). In other examples, the monitoring system (150) is used as a stand-alone system, and is disposable in any other location around the environment (100), e.g., insofar as the wireline cable (110) is extendable through the system (150).

To this end, while examples herein provide for a monitoring system (150) deployed at a well site, it is understood that the disclosure is not so limited. For instance, in some examples, monitoring system (150) is deployed in a storage facility for stored wireline drums (104) requiring inspection.

As shown in FIG. 7, monitoring system (150) generally includes a processor (702) coupled to a memory (704), an imaging subsystem (706), as well as one or more of a laser subsystem (708), display interface (710) and communication interface (712). In some examples, the system (150) only includes the imaging subsystem (706), without the laser subsystem (708).

The remaining discussion herein focuses on the imaging subsystem (706) and laser subsystem (706).

### (i.) Imaging Subsystem.

Imaging subsystem (706) (FIG. 7) is used for capturing and processing image data of the wireline (110), as it passes through the monitoring system (150). The images are analyzed using trained models which predict the presence of defects, as well as various defect features (e.g., defect type, location, severity and the like).

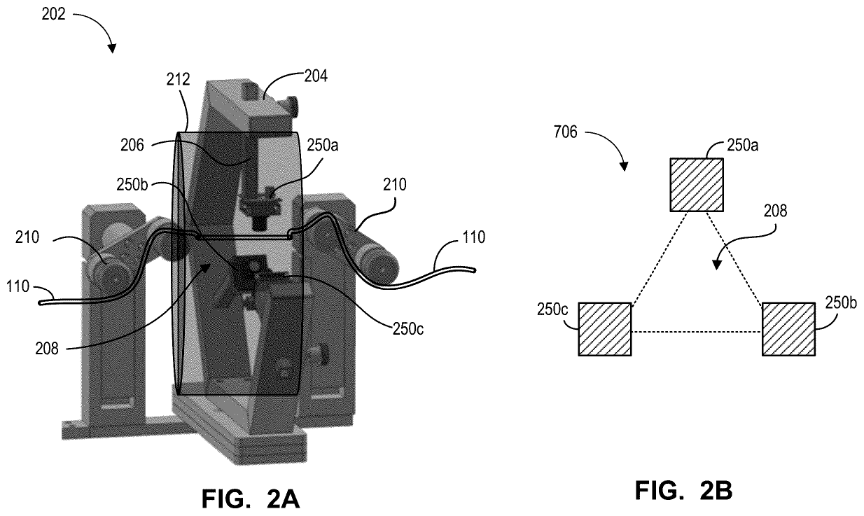

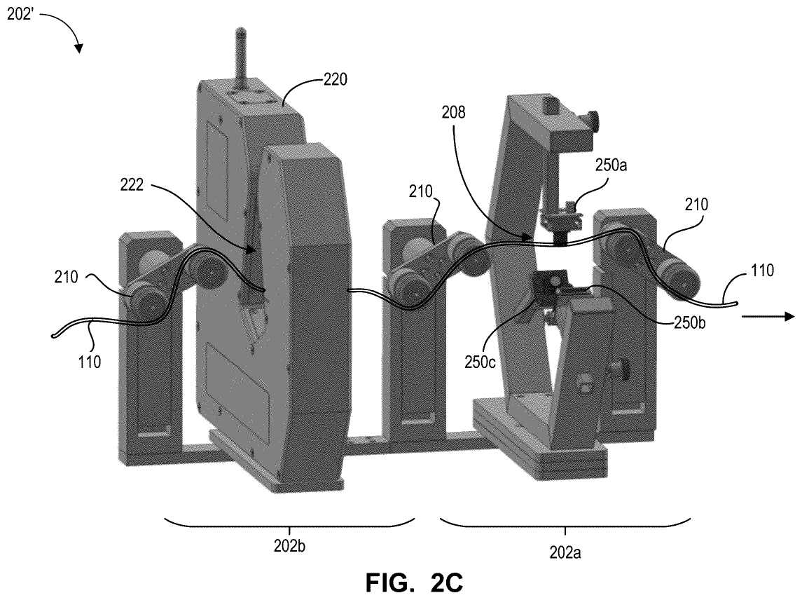

FIG. 2A exemplifies a hardware imaging assembly (202), forming part of the monitoring system (150). Hardware assembly (202) can support the imaging subsystem (706).

As exemplified, the imaging subsystem (706) includes an arranged assembly of one or more imaging sensors (250a)-(250c), collectively forming the imaging subsystem (706). Imaging sensors (250) include imaging cameras (e.g., red-green-blue (RGB), black and white, or the like). In some examples, the imaging sensors (250) are high-speed cameras (e.g., NileCam™ 25 cameras).

To provide mechanical support for the imaging sensors (250), hardware assembly (202) may include a mounting bracket (204) and one or more support members (206). Each support member (206) supports, and retains, an imaging sensor (250), as shown. In other examples, any other retention assembly is used.

As illustrated, the imaging sensors (250a)-(250c) surround, and are otherwise directed towards, an imaging area (208) (FIG. 2B). Wireline cable (110) passes through the imaging area (208) to allow sensors (250) to capture images of the wireline.

Imaging subsystem (706) can include any number of imaging sensors (250). Exemplified embodiments provide at least three imaging sensors (250a)-(250c). The three imaging sensors (250a)-(250c) may be arranged, and supported by hardware assembly (202), in a triangular configuration, around imaging area (208).

In this arrangement, an imaging sensor (250) is positioned to capture an image from each side (or view) of the wireline cable (110), and otherwise provide a 360° circumferential view of the wireline cable (110). This ensures that no wireline cable defects are hidden from view (e.g., in a blind spot).

In some examples, imaging sensors (250) are positioned equidistally from each other (e.g., at 60° angles). This ensures that no camera is disposed in the field of view of another camera, thereby obfuscating a captured image of wireline (110).

The imaging subsystem (706) can also include more than three imaging sensors (250), and arranged in any other desired configuration, e.g., to also provide a 360° circumferential view of the wireline cable (110).

As shown in FIG. 2A, the hardware assembly (202) may incorporate wireline cable-tension control structures (210) (e.g., pulley members). Tension control structures (210) operate to maintain the wireline (210) taught, as it passes through imaging area (208). In turn, this allows capturing higher-quality images of the wireline.

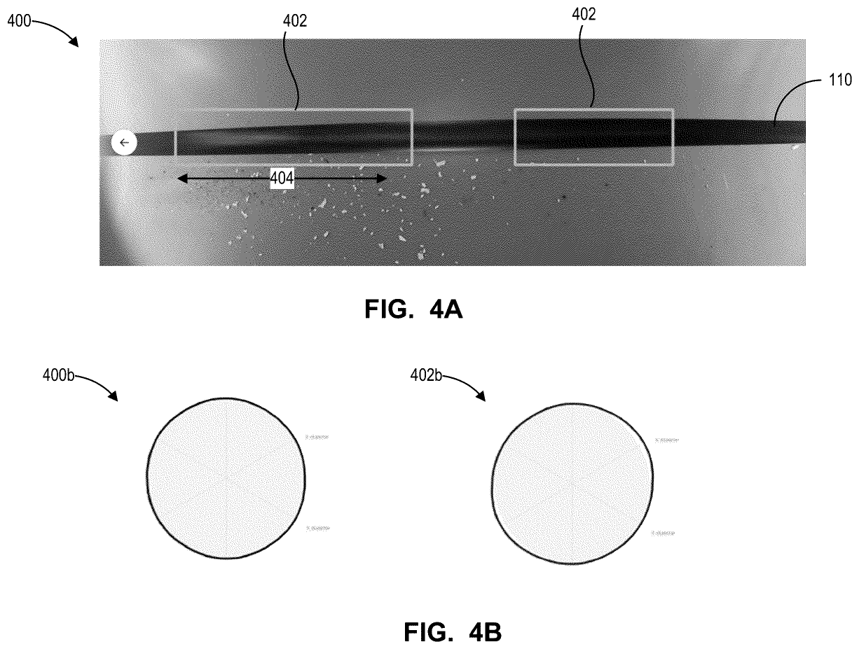

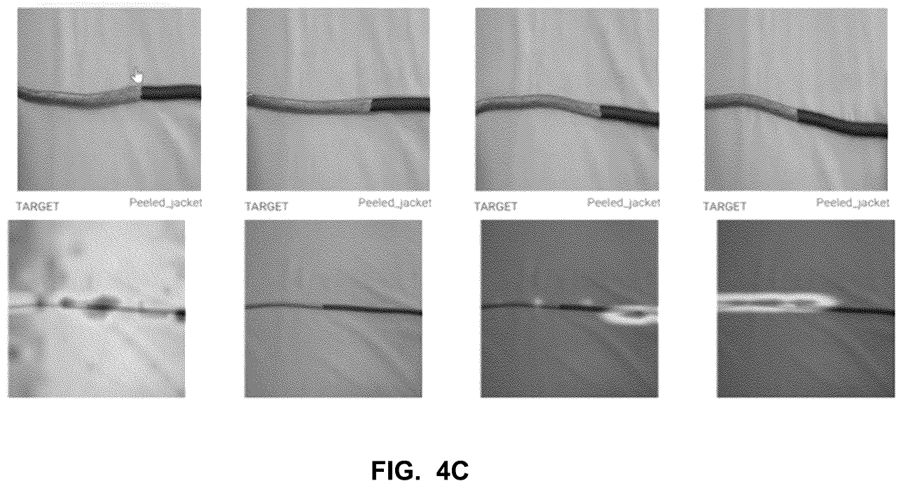

In at least one example, hardware assembly (202) incorporates a background medium (212) (FIG. 2A). The background medium (212) can be a green screen or the like. As exemplified, the background medium (212) at least partially surrounds the imaging area (208), all the while avoiding obscuring the imaging sensors' field of view. In the illustrated example, the background medium (212) is a cylindrical structure. As shown in FIG. 4C, the background medium ensures that images capture of wireline (210) are captured on an appropriate background that facilitates image analysis.

### (ii.) Laser Subsystem.

In addition to the imaging subsystem (706), monitoring system (150) can further include the laser subsystem (708) (FIG. 7).

Laser subsystem (706) generates laser measurement data. The laser measurement data is used for monitoring dimensional features of the wireline (110). Dimensional features include any geometric features of the wireline cable profile including, for example, wireline cable ovality and diameter. Dimensional features, generated by laser subsystem (708), provide a further source of defect detection, supplementing the imaging subsystem (706).

By way of illustrative example, FIG. 4B shows cross-sectional images of wireline cable profiles, generated using exemplary laser measurement data.

As shown, wireline cable profile (400b) provides an example of a wireline cable with appropriate dimensional features, while wireline cable profile (402b) provides an example of a wireline cable with distorted dimensional features (e.g., distorted ovality features).

FIG. 2C exemplifies a hardware assembly (202′), forming part of monitoring system (150). Compared to hardware assembly (202) (FIG. 2A), hardware assembly (202′) supports both the imaging subsystem (706) and the laser subsystem (708).

As exemplified, hardware assembly (202′) includes an imaging hardware subassembly (202a), and also further includes a laser hardware subassembly (202b). Imaging hardware subassembly (202a) can be generally analogous to the assembly (202), in FIG. 2A.

Laser hardware subassembly (202b) can include a housing (or other enclosure) (220), which retains the laser subsystem (708). In some examples, the laser subsystem (708) comprises: (i) one or more laser sources for generating a laser beam, and (ii) one or more associated light sensors for detecting laser reflected from the wireline (110). In at least one example, the laser assembly (202b) comprises a Proton InteliSENS™ laser system.

To that end, the laser subsystem (708) (e.g., laser sources and sensors) are arranged around, and directed towards, a laser scanning area (222) which receives the passing wireline (110). The laser subsystem (708) can be arranged around laser scanning area (222), to provide a 360° coverage around the wireline. In this manner, the laser subsystem (708) generates laser measurement data comprising three-dimensional (e.g., x, y and z) measurements of wireline cable ovality.

In the illustrated case, the laser subassembly (202b) is exemplified as positioned prior to the imaging subassembly (202a). However, in other examples, the subassemblies (202a), (202b) are positionally arranged in any other manner. Further, the subassemblies (202a), (202b) are not necessarily mechanically coupled, as illustrated.

### III. Example Method(S)

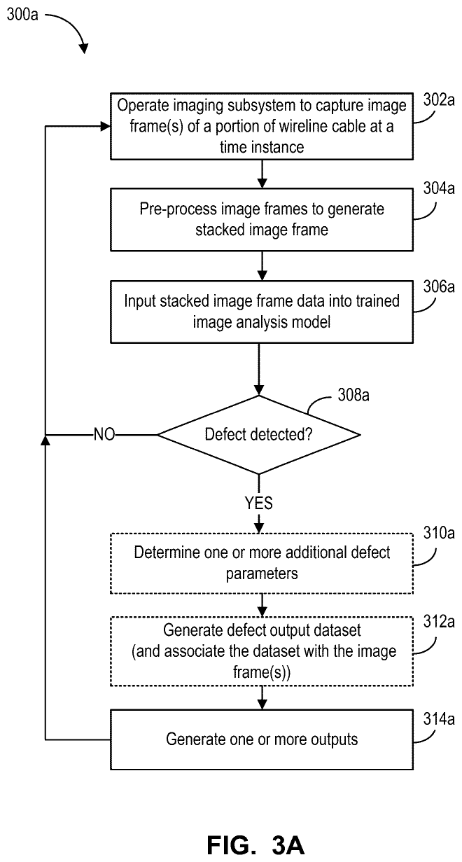

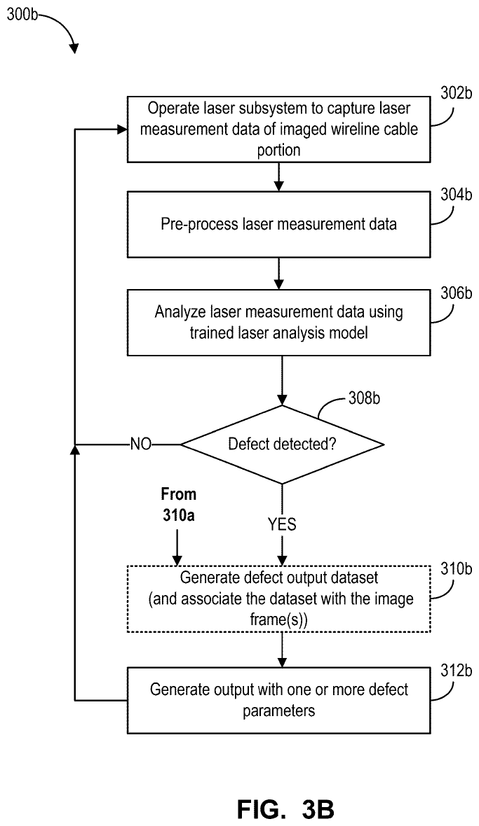

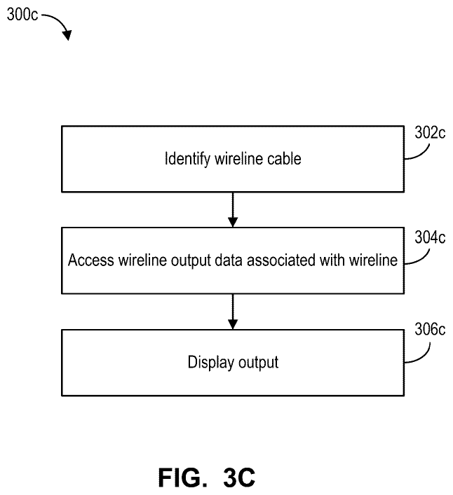

The following is a discussion of various example methods for automated detection of defects in wireline cables. The disclosed methods can be performed using a processor of one or more of the monitoring system (150), server (602) and/or user device (604) (FIG. 6). In at least one example, at least the methods in FIGS. 3A and 3B are performed using a combination of the processors of the monitoring system (150) and/or server (602).

### (i.) Automated Detection of Defects Using Imaging Subsystem.

FIG. 3A is an example method (300a) for automated detection of defects in wireline cables using a monitoring system (150) and using only imaging data generated by the imaging subsystem (706) (FIG. 7).

More generally, method (300a) assumes the monitoring system (150) may not necessarily include the laser subsystem (708), or otherwise, the laser subsystem (708) is not used.

Method (300a) can be performed in real-time, or near real-time, so as to provide defect detection in real-time, or near real-time.

As shown, at (302a), the imaging subsystem (706)—of monitoring system (150)—is operated to capture one or more image frames of the wireline cable (110), at a given time instance. The image frames are associated with the portion of the wireline cable, passing through an imaging area.

For example, in FIGS. 2A and 2B, one or more of the imaging sensors (250a)-(250b) are operated to capture a corresponding image frame of the wireline cable (110), passing through imaging area (208). Imaging sensors (250a)-(250b) can be synchronously operated to capture images frames at the same time instance, or substantially the same time instance (e.g., within a few milliseconds of each other). The number of image frames captured, at (302a), depends on the number of operated imaging sensors (250) (e.g., three imaging sensors results in three image frames generated at (302a), at a given time instance).

At (304a), image frames are pre-processed to generate processed image frames.

In some examples, the pre-processing involves assembling the multiple captured image frames, at (302a), into a single stacked image array frame (e.g., a NumPy array stack in Python computer language). The single stacked image frame may be resized and normalized. This pre-processing can facilitate the use of the trained image analysis model, which detects defects in the imaged wireline. In some examples, the stack has a batch dimension in addition to color channels, e.g. [12, 3, 512, 512] (12 frames×3 channels×512 pixels×512 pixels).

At (306a), the stacked image frame (e.g., the numerical array pixel data) is input into a trained image analysis model. The image analysis model is a trained machine learning model, trained to analyze the input data and output predictions for the presence or absence of defects in the imaged wireline portion. As used herein, a “defect” refers to any abnormality and/or aberration in the outer wireline cable profile which is either unexpected and/or undesired. Various example defect types are explained shortly below.

In at least one example, the model used at (306a), is also trained to output predictions of one or more “defect features”. Defect features refer to any features generally associated with a detected defect. For example, this includes, by way of non-limiting examples: (i) the defect type or class, (ii) defect severity, and (iii) image frame pixel coordinates where the defect is detected in the image frame.

With respect to the defect type, the model may be trained to predict the defect as one of a number of pre-defined defect categories, e.g., (i) general damage; (ii) cold deformity; (iii) peeled jacket; (iv) fluid migration; (v) bird cage or broken armor; and/or (vi) torque knot.

In some examples, the model is further trained to generate a bounding box in the input image frames, captured at (302a). The bounding box may be generated based on the image frame pixel coordinates, where the defect is detected (see e.g., bounding boxes (402) in FIG. 4A).

As provided, the trained image analysis model can be a trained objection detection model. For instance, this can be a trained single-stage YOLOX object detector model, as known in the art. The YOLOX model may be selected for its unique ability for real-time inferences during high-speed image processing, which is suited for the disclosed application.

At (308a), based on the model output (e.g., presence of a defect and/or defect features), a determination is made as to whether a defect is detected in the imaged wireline cable portion.

If no defect is detected, the method can return to act (302a) to continue monitoring new image frames, received from the imaging subsystem (706). For example, these can be new image frames of new wireline cable portions, as the wireline (110) continues to pass through the imaging area (208).

Otherwise, if a defect is detected—in some examples, at (310a), the system can determine one or more additional defect parameters. Additional defects parameters can include any other information, related to the defect, which is not necessarily predicted by the trained model.

In at least one example, the additional defect parameters include the wireline length range, associated with the detected defect.

For example, if the wireline cable extends for 3,000 meters, and the defect is detected in a 10 meter range, between 2,540 meters and 2,550 meters—the system can determine that the detected defect occurred in the wireline portion extending between 2,540 meters and 2,550 meters.

To this end, the system can monitor the length range, at which the defect occurs, in various manners. In some examples, this is determined based on the known speed at which the wireline cable is passing through the imaging area (208) (FIG. 2B), the known field of view (FOV) of the imaging sensors (706), and the frame rate of each imaging sensor (706).

For instance, if the wireline cable spooling speed, from the wireline drum (108) (FIG. 1), ranges from 150 meters/min to 250 meters/min (250 cm/second to 416.6 cm/second), with imaging sensors operating at 24 frames per second (FPS) and a 33 cm FOV-only two duplicate frames are captured of every portion of the wireline cable passing through the imaging area (208) (FIG. 2B). Accordingly, the system uses this information to monitor how much wireline cable has been spooled, and therefore, along what portion of the length of the wireline cable the imaged defect occurred (e.g., based on what portion of the wireline is passing through imaging area (208)).

In other examples, the additional defect parameters at (310a) can also include information regarding where and when the wireline operation occurred. This can be determined via a user input, or otherwise, automatically (e.g., via a GPS and/or timer module of the monitoring system (150)).

At (312a), the system can generate a “defect output dataset”. The defect output dataset can include any and all information related to the defect, as determined at any portion of method (300a). For instance, the defect output data can include one or more of: (i) an indication of the presence of a defect in the image frames, (ii) any determined defect features predicted by the trained model (e.g., size, intensity, pixel location), as well as (iii) additional defect parameters, determined at (310a) (e.g., length range, location and timestamp, etc.).

In at least one example, the defect output dataset is associated with one or more of the image frames, captured at (302a). For example, the output dataset is stored as metadata associated with the image frames (e.g., as an array of metadata).

In other examples, the output dataset is associated with image indices, whereby each image index is mapped to particular image frames. This can involve generating an array which includes different image indices, and the corresponding defect output dataset.

As provided below, the association data allows for “after the fact” review of wireline defects. For example, after a wireline operation is complete—an operator may desire to review historical or previously captured data of a defected wireline. The system can display the image frame(s) of the defected wireline, as well as retrieve any associated defect output datasets, linked to these image frame(s). This, in turn, allows the operator to review not only the image frames, but information in respect of the imaged defect.

Continuing with reference to FIG. 3A, at (314a) the system can generate one or more outputs, associated with the detected defect. The disclosure herein is not limited to any particular type of output.

In at least one example, the output is a user notification (e.g., visual and/or auditory). The user notification indicates the presence of a defect. This can alert the operator, in real-time or near real-time, that a defect is detected in the wireline (110). The notification can also provide various information in the associated defect output dataset (e.g., defect type, severity, etc.).

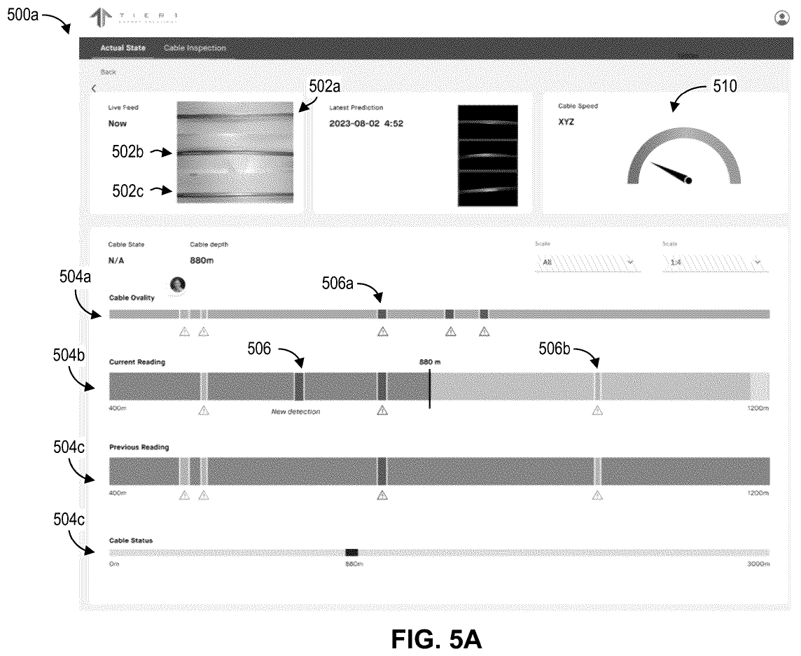

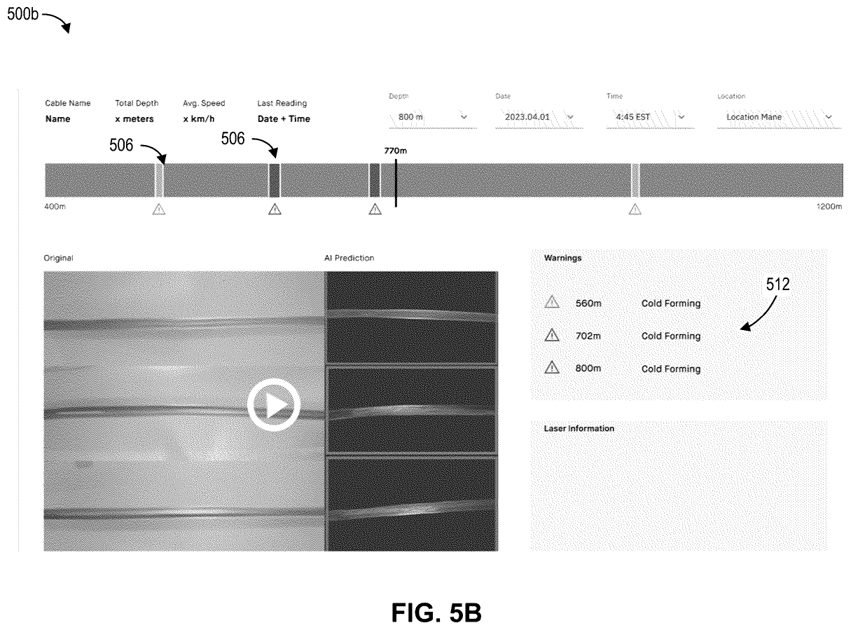

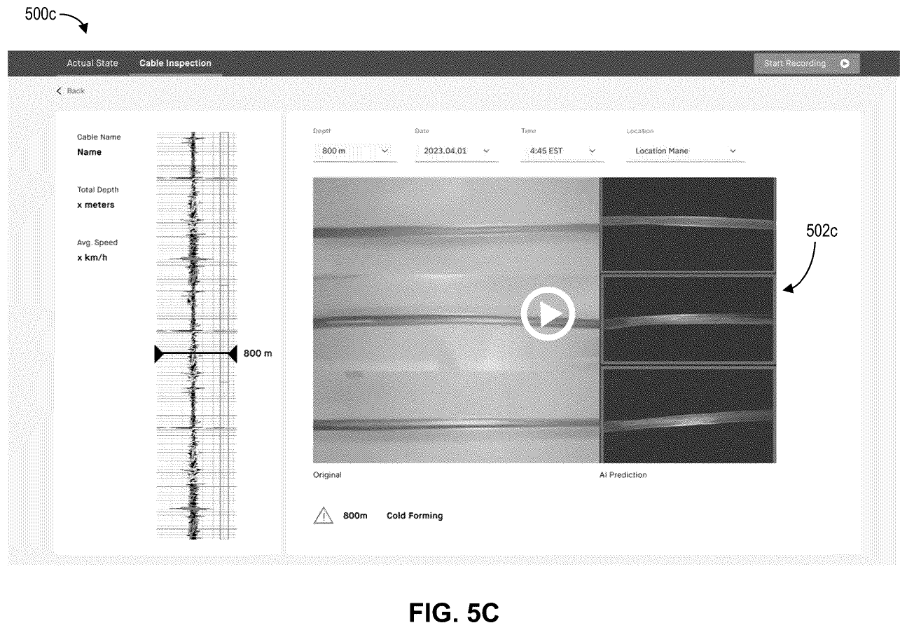

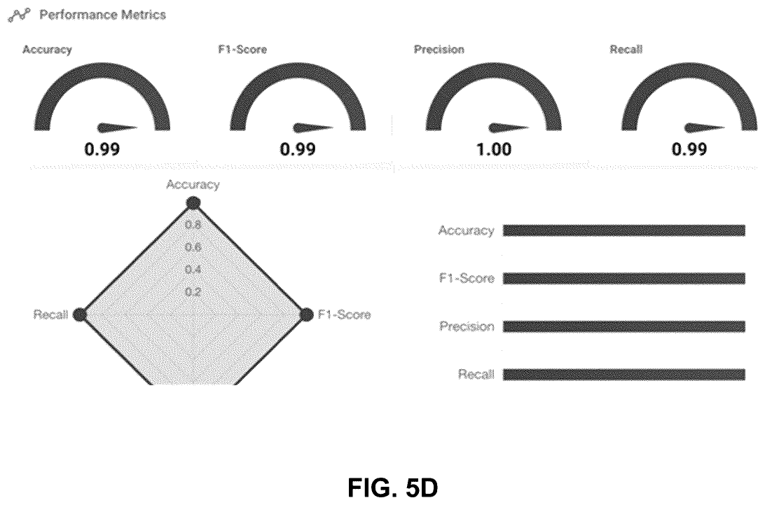

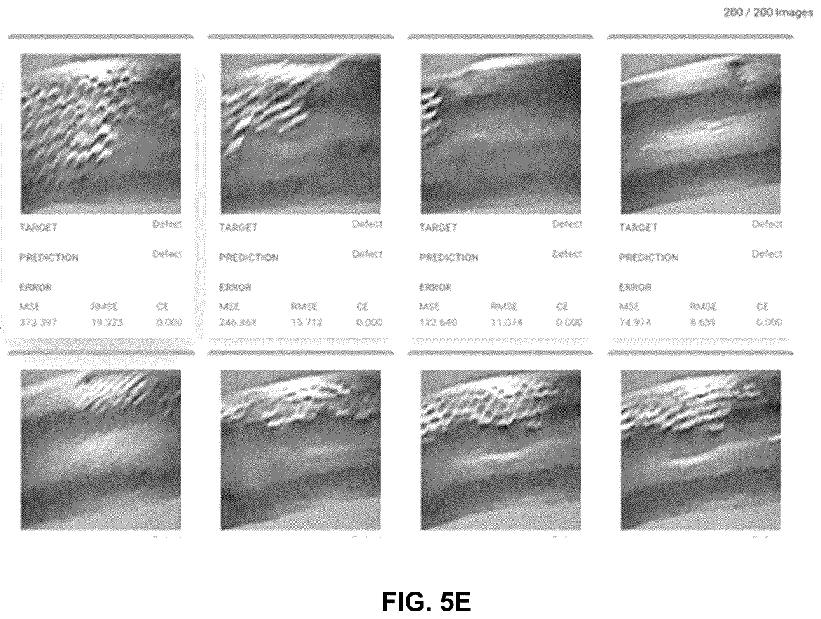

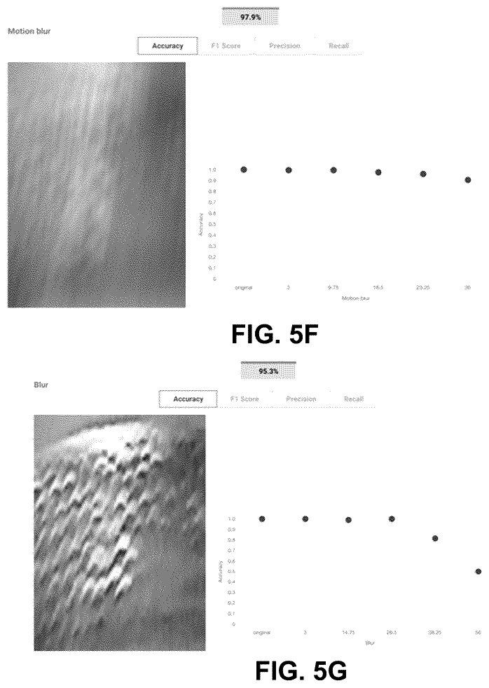

If the user is using a user device (604) (FIG. 6), the notification may be generated directly on the user device (604). In other cases, the notification is generated on the monitoring system (150). As explained with reference to FIGS. 5A-5C, in some cases, the user device (604) and/or monitoring system (150) can host a software for generating output graphical user interfaces (GUIs). The GUIs can generate and/or display the notification, as well as other related data.

In some examples, the output generated at (314a) includes a visualization of the detected defect. For example, as shown in FIG. 4A, bounding boxes (402) are generated (e.g., by the trained model), and overlaid (or superimposed) over images of the wireline portion where a defect is detected. As noted above, the model can be trained to generate a bounding box having a length (404) extending along an area of the wireline portion where the defect is present. To that end, the user can receive a live video feed of the wireline (e.g., on user device (604)), with bounding boxes overlaid in real-time or near real-time over the feed. This allows the user to observe the defected wireline, as it passes through the monitoring system (150).

In other examples, the output can be stored on a memory, such as on the memory of the monitoring system (150), and/or server (602) (FIG. 6). This allows the data to be reviewed and/or further processed at a subsequent point in time. For example, the output can comprise the defect output dataset, which is stored on memory.

In some examples, the system can store in memory, the association between the image frames and the output defect dataset. For instance, this can be stored in a relational database (e.g., PostgreSQL), which can be hosted on monitoring system (150) and/or server (602) (FIG. 6).

As shown, once (314a) is completed, the method can once again return to (302a) to continue monitoring new portions of the wireline cable.

In view of the foregoing, it is appreciated that method (300a) can provide an early warning system to notify wireline operators of risks of catastrophic failures. Over the course of time, this can enable better maintenance and strategic use of older or damaged wireline cables.

In some examples, method (300a) can iterate until all of the wireline (or any desired portion thereof) is inspected and analyzed. The result can be a plurality of defect output datasets, corresponding to various defects detected along various portions of the wireline. Each of the defect output datasets can be associated with corresponding image frame data.

As used herein, a “wireline output dataset” includes all of the defect output datasets and image frames, associated with the same wireline. In some examples, the wireline output dataset is updated each time the wireline is inspected by monitoring system (150) to add and/or subtract information.

In at least one example, the wireline output datasets is stored in memory in association with a unique wireline identifier (e.g., an ID number). This allows an operator to retrieve the wireline output dataset (e.g., for review) using the unique identifier.

### (ii.) Automated Detection of Defects Using Imaging and Laser Subsystems.

FIG. 3B is an example method (300b) for automated detection of defects in wireline cables using a monitoring system (150), and using data generated by both the imaging subsystem (706) and laser subsystem (708) (FIG. 7).

In some examples, method (300b) is performed in real-time, or near real-time, so as to provide defect detection in real-time, or near real-time.

As explained above, the laser subsystem (708) may provide a further mechanism for defect detection to the imaging subsystem (706), by monitoring wireline cable profile dimensions (e.g., diameter and/or ovality) (FIG. 4B).

In some examples, acts (302b)-(308b) in FIG. 3B occur concurrently, or partially concurrently, with acts (302a)-(310a) of FIG. 3A. In at least one example, acts (302b)-(308b) occur slightly before, or after, acts (302a)-(310a), depending on whether the laser hardware assembly (202b) (FIG. 2C) is positioned before or after the imaging hardware assembly (202a).

As shown in FIG. 3B, at (302b), the laser subsystem (706) is operated to capture laser measurement data, of the same wireline cable portion imaged at (302a) (FIG. 3A). In some examples, the laser measurement data comprises x, y, and z measurements (e.g., millimeter and/or nanometer) of wireline cable profile dimensions, e.g., wireline cable ovality. The laser measurement data can be generated by the light sensors incorporated in the laser subsystem (708).

At (304b), the laser measurement data can be pre-processed (e.g., removing noise artifacts, remove anomalies, etc.).

At (306b), the laser measurement data is analyzed to determine the presence (or existence) of a defect in the wireline cable portion.

In some examples, act (306b) involves inputting the laser measurement data into a trained laser analysis model. For example, this can be a trained tabular model, which is trained on x, y, z diameter lengths, wireline cable speed, and ovality metrics to predict defects (e.g., damaged or torsion sections) in the wireline cable. The tabular-data model then outputs predicted classifications of tabular inputs as “defected” or “non-defected”. The model can also output predictions of one or more defect features, as noted above (e.g., type, severity, etc.)

At (308b), based on the output of the trained model, a determination is made as to whether the wireline cable portion is defected or not defected. If there is no defect, the method returns to act (302b), and iterates on the next wireline cable portion.

Otherwise, at (310b), the system can generate the defect output dataset. Act (310b) is generally analogous to act (310a), with the exception that the defect output dataset also includes the output of the trained laser analysis model. Further, this data can also be associated with the image frame(s) captured at (302a). In some examples, it may also be time-stamped and/or associated with a depth or wireline cable length measurement.

At (312b), outputs can be generated in an analogous manner, as previously explained with reference to act (310a).

As method (300b) is iterated overtime, the wireline output dataset can also include the defect analysis from the laser model. In turn, this provides another data stream for analyzing defects, whereby each time stamp and/or cable length (or depth measurement) is associated with one or more defect data generated by the imaging subsystem and/or laser subsystem.

### (iii.) Non-Real Time Application.

While methods (300a) and (300b) are described in relation to real-time, or near real-time, monitoring of defects in wireline cables—in other examples, the same methods are applied to non-real time analysis.

For example, each of acts (302a) and (302b) may be performed at a first-time instance, using the monitoring system (150) (or any other analogous system). The image frames and laser measurement data generated at (302a) and (302b) are then stored in memory, e.g., of monitoring system (150), sever (602) and/or user device (604) (FIG. 6). At a subsequent point in time, the data is accessed and further analyzed in accordance with the remainder of methods (300a) or (300b).

In some examples, methods (300a) and/or (300b) simply omit acts (302a) and (302b).

### (iv.) Historical Wireline Defect Data.

FIG. 3C shows an example method (300c) for displaying previously captured (e.g., historical) wireline output data.

For example, after the wireline is analyzed using the methods described in FIGS. 3A and/or 3B, the operator may desire to review the data at a subsequent time, to observe the detected defects. This may allow the operator to make determinations regarding how to fix or repair the wireline, or whether the wireline can be used in certain applications (e.g., high stress applications).

At (302c), the system can identify the wireline for which the historical data is being retrieved for. For example, as noted above, different wireline drums (or wireline trucks) can be associated with different unique identifiers. The user can, for example, input an identifier into the user device (604).

At (304c), the system can access (e.g., retrieve) the wireline output data, associated with that wireline identifier. For example, a memory of any computing system in FIG. 6, may store a reference lookup of wireline identifiers, and the corresponding wireline output data.

At (306c), an output is generated that includes the wireline output data. FIGS. 5A-5C, described below, exemplify some of these outputs.

### IV. Example Graphical User Interfaces (GUIs)

FIGS. 5A-5C illustrate various example graphical user interfaces (GUIs) (500a)-(500c) output by the system, and which can be used to visualize the wireline cable monitoring data.

In some example, GUIs (500a)-(500c) are displayed on a display interface of a user device (604) (FIG. 6), a display interface of the monitoring system (150) (FIG. 7) or any other computing device.

The GUIs can provide an operations dashboard for wireline operators to interact with the monitoring system (150). In at least one example, the GUIs can also allow operators to view current wireline operations and/or defects from historical wireline operations. In some examples, the GUI dashboards display run data per wireline cable, and per run.

FIG. 5A shows an example GUI (500a). As shown, the GUI (500a) can include various live video feeds (502a)-(502b), from each imaging sensor (706) (e.g., camera). Accordingly, the GUI (500a) shows three live video feeds from the three live cameras (FIGS. 2A and 2B), and displaying the wireline (110) as it passes through imaging area (208). This allows the operator to view the wireline, and any defects, in real-time or near real-time.

The GUI (500a) can also display various indicia (506) identifying wireline defects recorded in previous runs of the wireline. For example, this can be generated based on retrieved wireline output data, previously captured in association with the wireline (FIG. 3C). In this example, the indicia can be overlaid over depth-wise timelines (504a)-(504b) of the wireline cable, and showing the location of the defects mapped to different length regions of the wireline. Accordingly, this can be used to alert the operator of upcoming wireline cable damage (e.g., “Warning! In 50 m, there is damage”). This may improve the operator's ability to be prepared to inspect damages and assess their potential severity.

The GUI (500a) can also show various other information, such as wireline cable speed (510) and wireline cable status (504c).

GUI (500b) exemplifies a similar GUI, but further including a defect classification (512) for the operator's benefit.

GUI (500c) exemplifies a GUI and showing post-processing (502c) with the background stripped out of the image of the wireline cable.

While the GUIs (500a)-(500c) are exemplified for real-time, or near real-time monitoring, a similar interface can allow for offline review of wireline cable monitoring data.

For example, before field operations, operators can use the dashboard to review the location of wireline cable defects, and review the timelines and captured videos across the entire length of the wireline cable (as determined from previous runs). This provides better identification of defects that could lead to wireline cable failure. Afterwards, during field operations, a continuous 360-degree camera view and wireline cable ovality measurements will provide a more sophisticated, complete and informative view of the wireline cable.

### V. Example Defect Detection Model

The following is a further description of: (i) the trained image analysis model, used at act (306a) (FIG. 3A), as well as, (ii) the trained laser analysis model, at act (306b) (FIG. 3B).

### (i.) Image Analysis Model.

As explained above, the trained image analysis model-used at act (306a) (FIG. 3A)—can be a trained machine learning model.

In at least one example, the model is a deep neural network object detection model, such as a trained YOLOX object detection model, as known in the art.

At a general level, YOLOX models operate by dividing an image into a grid of cells, whereby each cell predicts the presence of multiple bounding boxes and class probabilities for objects in that cell. In at least one example, the YOLOX model produces multiple bounding box detections of anomalies per frame.

In disclosed examples, the YOLOX model is trained to detect the presence of defects in imaged wireline cables, and generate bounding boxes around the location of the defect in the image (e.g., bounding box (402) in FIG. 4A). During training, the bounding boxes are adjusted by the model to refine the predictions.

In some examples, the model is trained with annotated training images. For instance, as shown in FIG. 4A, a training image can display a specific wireline defect, including an annotated bounding box in the defect location (or associated pixel coordinates), and can also include one or more defect features (e.g., defect type, intensity, etc.). In some examples, each wireline defect is identified as being one of six defect types: (i) general damage; (ii) cold deformity; (iii) peeled jacket; (iv) fluid migration; (v) bird cage; (vi) broken armor; and/or (vii) torque knot. The training images can contain various unique augmentations, reflective of actual industrial settings.

To this end, the selection of the YOLO family of object detection models results from their ideal accuracy and floating-point operations (FLOP) ratio, as well as their enhanced ease-of-use (i.e., ergonomics) to allow analysis of the object detection results by a wireline operator. YOLO models also provide distinct patch-based structures, which complete detections using a subdivided image grid, with confidence measures per patch.

With respect to training, in some examples, the model training runs are logged and tracked via specialized platform (e.g., MLFlow, Weights & Biases, or AWS SageMaker).

In at least one example, the image analysis model can also be one of ResNet100, ResNet50, and EfficientNet.

### (ii.) Training Methodology for Image Analysis Model Using YOLOX.

In an example where a YOLOX model is used for each of the imaging and laser models, transfer learning is used taking the base YOLOX model which is trained for 80 classes of defect types, and then transfer learning is performed on it for three classes: defects, no defects and welding. Example training parameters are as follows:
Learning_rate: 0.01
Batch_size: 32
Optimizer: Adam.
Image size: 640×640
Number of epochs: 1000
Data Augmentation: Mix up and mosaic techniques
80-20 split for the validation set
Use of Validation Set: Throughout training, a separate validation set is used to monitor the model's performance on unseen data. This helps in tuning hyperparameters and avoiding overfitting.
Early Stopping: To prevent overfitting, training can be halted early if the model's performance on the validation set does not improve for a specified number of epochs.

### (iii.) Training Methodology for Image Analysis Model Using Resnet50 and Resnet101.

In an example where a Resnet-50 or Resnet-100 model is used for each of the imaging and laser models, then transfer learning is used for Resnet-50 and Resnet-100 taking the base Resnet model that is trained for 1000 classes of defect types, and then performing the transfer learning on it for three classes defects, no defects and welding. Example training parameters are as follows:
Learning_rate=0.01.
Batch_size=32
Optimizer: Adam
Image size: 1024×1024.
Number of epochs: 100
80-20 split for the validation set
Throughout training, a separate validation set is used to monitor the model's performance on unseen data. This helps in tuning hyperparameters and avoiding overfitting.
Early Stopping: To prevent overfitting, training can be halted early if the model's performance on the validation set does not improve for a specified number of epochs.
The following implementation parameters are further used for the image analysis model:

| | |
|---|---|
| Data Augmentation | test_generator = |
| datagen = ImageDataGenerator( | datagen.flow_from_directory( |
| shear_range=0.1, | target_size=(targetx, targety), |
| zoom_range=0.1, | batch_size=batch_size, |
| brightness_range=[0.9,1.1], | class_mode=‘categorical’, |
| horizontal_flip=True, | shuffle=False, |
| validation_split=testsplit, | seed=seed, |
| preprocessing_function=preprocess_input | subset=“validation” |
| ) | ) |
| train_generator = datagen.flow_from_directory( | |
| target_size=(targetx, targety), | |
| batch_size=batch_size, | |
| class_mode=‘categorical’, | |
| shuffle=True, | |
| seed=seed, | |
| subset=“training” | |
| ) | |

### (iv.) Training Methodology for Image Analysis Model Using EfficientNet.

In an example where EfficientNet is used for training the image analysis model, tansfer learning is used for EfficientNet taking the base EfficientNet model which was trained for 1000 classes of defect types, and then transfer learning is performed on for three classes defects, no defects and welding. Example training parameters are as follows:
Learning_rate: 0.0001
Batch_size: 4
Optimizer: Adam
Image Size: 512×512 (in the case of the imaging analysis model).
Number of Epochs: 20
80-20 split for the validation set
Throughout training, a separate validation set is used to monitor the model's performance on unseen data. This helps in tuning hyperparameters and avoiding overfitting.
Early Stopping: To prevent overfitting, training can be halted early if the model's performance on the validation set does not improve for a specified number of epochs.
The following implementation parameters are further used for the image analysis model:

| | |
|---|---|
| Data Augmentation | test_generator = |
| datagen = ImageDataGenerator( | datagen.flow_from_directory( |
| shear_range=0.1, | target_size=(targetx, targety), |
| zoom_range=0.1, | batch_size=batch_size, |
| brightness_range=[0,9,1.1], | class_mode=‘categorical’, |
| horizontal_flip=True, | shuffle=False, |
| validation_split=testsplit, | seed=seed, |
| preprocessing_function=preprocess_input | subset=“validation” |
| ) | ) |
| train_generator = datagen.flow_from_directory( | |
| target_size=(targetx, targety), | |
| batch_size=batch_size, | |
| class_mode=‘categorical’, | |
| shuffle=True, | |
| seed=seed, | |
| subset=“training” | |
| ) | |

### (v.) Output Results.

FIGS. 5D-5G demonstrate high accuracy, F1, precision, and recall with the most recent EfficientNet model and for the image analysis model.

### (vi.) Laser Analysis Model.

In at least one example, the laser measurement data is analyzed using a binary classification gradient-boosted tree with XGBoost, which comprises the trained laser analysis model used at (306b) (FIG. 3B). Gradient boosting involves creating and adding decision trees one at a time, where each successive tree corrects for prediction errors made by the previous tree in the series. XGBoost is selected because it is efficient, and provides highly accurate results without requiring significant computation, training time, or hyperparameter tuning.

In respect of training, large amounts of laser data are produced both during prototype testing and infield wireline operations. This data is labeled based on the severity of defects, and the defect category.

In at least one example, the model is trained to generate a binary classification, and to predict a defect or non-defect from the input data.

In some examples, the training data for the laser analysis model (306b) (FIG. 3B) can be a database of tabular data that is collected by the laser sensor for sample defected wireline cables. The table data can include various information for each analyzed training cable, including: (video_offset_ns INTEGER, length_mm INTEGER, x_dia_nm INTEGER, y_dia_nm INTEGER, z_dia_nm INTEGER, avg_dia_nm INTEGER, ovality_nm INTEGER, line_speed INTEGER) (i.e., ‘dia’=diameter in each axis). In some examples, a 15 minute run of the cable generates 13,108 rows. In this case, the laser analysis model is fed these geometric integer measurements, as well as the (i) the defect type or class, and (ii) defect severity (as explaiend above), associated with the determined measurements. In this manner, the model can associate different types and severities of defects with different geometric properties.

### VI. Example System

FIG. 6 shows an example overall system (600) for automated monitoring of defects in wireline cables.

As shown, system (600) includes a monitoring system (150) coupled, via network (610), to one or more external servers (602) and user devices (604).

In some examples, the system (600) can include more than one monitoring system (150), although only a single system is illustrated. For example, different systems may be associated with different wireline trucks and/or storage facilities.

User device (604) can include any computing device, and including various personal computing devices (e.g., phones, laptops, desktop computers, tablets, etc.).

In some examples, the user device (604) is used for viewing monitoring data, associated with a wireline cable monitored via monitoring system (150). The monitoring data can be received directly from one or more of the monitoring systems (150) and/or in-directly from one or more servers (602). In at least one example, the data can be received in real-time, or near real-time from the monitoring system (150).

The user device (604) can also host a software, which can generate the graphical user interfaces (GUIs) previously described (e.g., FIGS. 5A-5C). This can allow displaying various monitoring data including, displaying and visualizing measurements, sensor data (e.g. wireline cable speed, ovality, wireline cable depth), video feed, and outputs for critical operational alerts. The monitoring data can be displayed and updated on the display interface (610) in real-time, or near real-time.

Server (602) can include at least a processor, a memory and a communication interface (as each is defined below). Although a single server is shown, system (600) can include multiple servers.

In some examples, server (602) is used for training the models disclosed herein (e.g., the image analysis model, and laser analysis model). In some cases, server (602) may store training data, which is used for training the models.

In at least one example, once the models are trained, they are “pushed” (e.g., transmitted) from server (602) to the monitoring system (150). The trained models may then reside on a memory of the monitoring system (150), and used locally. In this manner the monitoring system (150) functions as an “edge AI” device. In these examples, the output from the models can be generated directly on the monitoring system (150), and optionally transmitted from the monitoring system (150) to one or more of the server (602) and/or user device (604).

In some cases, the monitoring system (150) can transmit the outputs of the trained models, as well as the input data. This can allow for re-training the models on the server (602), and allowing the server to transmit updated models back to the monitoring system (150) over time.

In other examples, the server (602) may store one or more of the trained models. In these examples, the server (602) can receive the raw data and/or partially processed data from monitoring system (150) (e.g., image frames and/or laser measurement data). The server (602) may then, itself, apply the trained models to generate the outputs. The outputs can be stored on the server (602) and/or transmitted to user device (604).

### VII. Example Electrical Hardware Configuration for Wireline Monitoring System

FIG. 7 shows an example electrical hardware configuration for the wireline monitoring system (150).

As shown, system (150) includes a processor (702) coupled to a memory (704), the imaging subsystem (760). In some example, processor (702) is further coupled to one or more of the laser subsystem (780), a display interface (710) and a communication interface (712).

As used herein, “processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), graphical processing units (GPU), and digital signal processors.

In some examples, processor (702) comprises one or more GPUs, that includes one or more processing containers. The use of GPUs can allow the wireline monitoring system (150) to operate complex trained machine learning models, and act as an edge-device in system (600) to process data in-situ and process image frames generated at high speeds (e.g., 60 frames per second). In turn, this can allow the wireline monitoring system (150) to provide real-time, or near real-time, monitoring of wireline defects, and provide real-time predictions. In at least one example, the processor (702) is an NVIDIA™ Jetson™ platform.

Memory (704) comprises a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

In some examples, memory (704) stores one or more trained machine learning models (750), as described herein. Memory (704) can also be configured with significant data storage capacities.

The imaging and laser subsystems (706), (708) may be as described herein.

The display interface (710) can be any interface for outputting data (e.g., visual and/or auditory). Communication interface (712) can be any interface for receiving and/or transmitting data, e.g., via network (602) (FIG. 6) (e.g., an antenna).

### VIII. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for automated detection of defects in wireline cables, comprising:
analyzing, using a trained image analysis model, one or more image frames, captured of a wireline cable portion at a given time instance using an imaging subsystem, wherein the model is trained to predict the presence of defects in imaged wireline cables;
based on an output of the trained image analysis model, determining the presence of one or more defects in the imaged wireline cable portion; and
if one or more defects are detected, generating an output.

2. The method of claim 1, comprising, initially, operating the imaging subsystem to capture the one or more image frames, wherein the imaging subsystem comprises at least three imaging sensors, each operable to capture a corresponding image frame of the wireline cable portion.

3. The method of claim 2, wherein the imaging sensors are arranged around an imaging area to provide a 360° circumferential view of the wireline cable portion, and are supported by an imaging hardware assembly.

4. The method of claim 3, wherein the imaging sensors are arranged in a triangular configuration.

5. The method of claim 1, wherein the trained image analysis model is a trained YOLOX model.

6. The method of claim 1, wherein prior to inputting the image frames, combining the image frames to generate a stacked image frame, and inputting the stacked image frame into the trained image analysis model.

7. The method of claim 1, wherein the trained image analysis model is also trained to predict one or more defect features.

8. The method of claim 7, wherein the defect features include one or more of defect type, defect severity, pixel location of defect within the one or more image frames.

9. The method of claim 1, wherein the output comprises a user notification of a detected defect.

10. The method of claim 1, further comprising:
generating a defect output dataset comprising one or more of: (i) an indication of the presence of the defect in the image frames; and (ii) one or more defect features; and
associating the defect output dataset with one or more of the image frames.

11. The method of claim 10, comprising iterating the method for a length of wireline and generating a wireline output dataset comprising a plurality of defect output datasets.

12. The method of claim 9, wherein the one or more defects comprise one or more first defects, and the method further comprising:
analyzing laser measurement data, of the wireline cable portion captured using a laser subsystem, using a trained laser analysis model, the trained laser analysis model being trained to predict the presence of one or more second defects in the wireline cable portion based on the laser measurement data;
based on the analysis, determining the presence of one or more second defects in the wireline cable portion; and
if one or more second defects are detected, generating the defect output dataset to include an indication of the one or more second defects.

13. The method of claim 12, further comprising operating the laser subsystem to capture the laser measurement data of the wireline cable portion, wherein the laser subsystem comprises one or more laser sources, as well as laser sensors which generate the laser measurement data.

14. The method of claim 13, wherein the trained laser analysis model is a binary classification gradient-boosted tree with XGBoost.

15. A system for automated detection of defects in wireline cables, comprising:
an imaging subsystem configured to generate one or more image frames, captured of a wireline cable portion at a given time instance;
a memory for storing a trained image analysis model, wherein the model is trained to predict the presence of defects in imaged wireline cables; and
at least one processor coupled to the memory and imaging subsystem, and configured for:
analyzing the one or more image frames using the trained image analysis model;
based on an output of the trained image analysis model, determining the presence of one or more defects in the imaged wireline cable portion; and
if one or more defects are detected, generating an output.

16. The system of claim 15, wherein the imaging subsystem comprises at least three imaging sensors, each operable to capture a corresponding image frame of the wireline cable portion.

17. The system of claim 16, wherein the imaging sensors are arranged around an imaging area to provide a 360° circumferential view of the wireline cable portion, and are supported by an imaging hardware assembly.

18. The system of claim 15, wherein the trained image analysis model is also trained to predict one or more defect features.

19. The system of claim 15, wherein the one or more defects comprise one or more first defects, the system further comprising a laser subsystem configured to generate laser measurement data of the wireline cable portion, and
wherein the memory is configured to store a trained laser analysis model trained to predict the presence of one or more second defects in the wireline cable portion based on the laser measurement data, and
the at least one processor is further configured for:
analyzing the laser measurement data using the trained laser analysis model;
based on the analysis, determining the presence of the one or more second defects in the wireline cable portion; and
if one or more second defects are detected, generating the defect output dataset to include an indication of the one or more second defects.

20. The system of claim 19, wherein the laser subsystem comprises one or more laser sources, as well as laser sensors which generate the laser measurement data.
